(19) United States
(12) Patent Application Publication
(10) Pub. No.: US 2014/0158247 A1
(43) Pub. Date: Jun. 12, 2014

(54) FLEXIBLE UNBONDED PIPE

(71) Applicant: Mikael Kristiansen, Hellerup (DK)

(72) Inventor: Mikael Kristiansen, Hellerup (DK)

(73) Assignee: NATIONAL OILWELL VARCO DENMARK I/S, Brondby (DK)

(21) Appl. No.: 14/117,110

(22) PCT Filed: Apr. 12, 2012
(86) PCT No.: PCT/DK12/50122

§ 371 Date: Dec. 11, 2013

(30) Foreign Application Priority Data
May 13, 2011 (DK) PA2 2011 00371

(51) Int. Cl. F16L 11/08

(52) U.S. Cl. CPC F16L 11/082
USPC 138/132; 138/129

(57) ABSTRACT

The invention relates to an unbonded flexible pipe for offshore applications comprising an internal sealing sheath and at least one armoring layer comprising at least one helically wound fibre containing elongate armoring element, wherein the fibre containing elongate armoring element comprises polymer material, and at least about 5% by weight of polypropylene fibers.

### TECHNICAL FIELD

The present invention concerns a flexible unbonded pipe for sub sea fluid transfer, for example for transporting water or aggressive fluids, such as petrochemical products, e.g. from a production well to a sea surface installation.

### BACKGROUND ART

Flexible unbonded pipes of the present type are for example described in the standard “Recommended Practice for Flexible Pipe”, ANSI/API 17 B, fourth Edition, July 2008, and the standard “Specification for Ubonded Flexible Pipe”, ANSI/API 17J, Third edition, July 2008. Such pipes usually comprise an inner liner also often called an inner sealing sheath or an inner sheath, which forms a barrier against the outflow of the fluid which is conveyed in the bore of the pipe, and one or more armoring layers. In general flexible pipes are expected to have a lifetime of 20 years in operation.

Examples of unbonded flexible pipes are e.g. disclosed in WO0161232A1, U.S. Pat. No. 6,123,114 and U.S. Pat. No. 6,085,799.

The term “unbonded” means in this text that at least two of the layers including the armoring layers and polymer layers are not bonded to each other. In practice the known pipe normally comprises at least two armoring layers located outside the inner sealing sheath. These armoring layers are not bonded to each other directly or indirectly via other layers along the pipe. Thereby the pipe becomes bendable and sufficiently flexible to roll up for transportation.

A pipe of the above type will for many applications need to fulfill a number of requirements. First of all the pipe should have a very high mechanical strength to withstand the enormous forces it will be subjected to during transportation, laying down and in operation. The internal pressure (from inside of the pipe and outwards) and the external pressure (from outside of the pipe) are usually very high and may vary considerably along the length of the pipe, in particular when applied at varying water depths. If the pipe resistance against the internal pressure is too low, the internal pressure may ultimately result in that the pipe is damaged by burst. If the pipe resistance against the external pressure is too low, the external pressure may ultimately result in deformation and collapse of the inner sealing sheath which acts as the primary barrier against outflow of a fluid transported in the flexible pipe. Simultaneously the flexible pipe may be subjected to highly corrosive fluids and chemical resistance may be needed. Furthermore, it is often desired to keep the weight of the pipe relatively low, both in order to reduce transportation and deployment cost but also in order to reduce risk of damaging the pipe during deployment.

In traditional flexible pipes, the armoring layers often comprise metallic armoring layers including a metal carcass typically wound from preformed or folded stainless steel strips and a number of armoring layers in the form of helically wound profiles or wires, where the individual layers may be wound with different winding angles relative to the pipe axis in order to take up the forces caused by the internal and external pressure as well as forces acting at the ends of the pipe and shear forces from the surrounding water.

When subjected to hydrostatic pressure in the sea the carcass of the prior art pipe will usually be designed to be sufficiently strong to withstand the hydrostatic pressure, and the armoring layers in the form of helically wound profiles or wires should be designed to be sufficiently strong to withstand internal pressure and tearing in the length direction of the pipe.

In the prior art it has been suggested to replace one or more of the metallic armoring layers with armoring layers of fibers or fiber reinforced polymer of different structures. U.S. Pat. No. 6,165,586 for example discloses a strip of filamentary rovings of glass fibre or aramid fibre sampled with bonding material and retaining means. It is suggested to use such strips to replace one or more metallic armoring layers of an unbonded flexible pipe.

In WO 01/51839 a flexible unbonded pipe comprising a tensile armoring layer of aramid fibers embedded in a thermoplastic material is disclosed.

In “Recommended Practice for Flexible Pipe”, ANSI/API 17 B, fourth Edition, July 2008 it is mentioned that composite materials can be used in the tensile armor layers. The reinforcing fibers used in such composites are E-glass, carbon and aramid fibers. The glass-fibre composite is more economical than the carbon fibre material but the carbon-fibre material has more favorable strength properties and characteristics. For both glass and carbon-fibre composites, the reinforcing fibers are predominately orientated parallel to the wire longitudinal axis.

Generally carbon fibers have been the preferred choice in particular for pipes for dynamic applications, because the armoring layers of flexible pipes in dynamic applications, e.g. as risers, are subjected to extensive wear. However, carbon fibers are very expensive and mainly for cost reasons the carbon fibers have been replaced with glass fibers and/or in particular aramid fibers.

The object of the invention is to provide a novel armored flexible pipe suitable for offshore applications, which pipe has a high and durable strength even when subjected to high mechanical stress and turbulence while simultaneously the flexible pipe can be manufactured in a cost effective manner compared to state of the art composite armored flexible pipes.

### DISCLOSURE OF INVENTION

The present invention provides a novel flexible unbonded pipe which meets this object. The flexible pipe of the invention and embodiments thereof have shown to have a large number of advantages which will be clear from the following description.

Although polypropylene fibers have been known and produced for more than 40 years—e.g. as described in U.S. Pat. No. 3,432,110 from 1969, no one—prior to the inventor of the present invention—has ever considered applying polypropylene fibers in flexible unbonded pipes. The inventor of the present invention has realized that polypropylene fibers can beneficially be applied in flexible unbonded pipes, and further it has been found that the polypropylene fibers have a sufficiently high resistance against hydrolysis to be applied in offshore applications.

The flexible unbonded pipe of the invention has shown to have a surprisingly high and durably strength relative to the thickness and weight of the armoring layers of the pipe—and in particular relative to the weight of the polypropylene fibers. Furthermore it has been found that even when subjected to an aggressive environment under dynamic circumstances e.g. as risers, the fibre containing elongate armoring element is both strong and very resistant to hydrolysis, which makes the resulting unbonded flexible pipe very suitable for deep water application and risers. It has been found that the polypropylene fibers show no significant sign of hydrolyses even after months in acidic water, and therefore the amount of required polypropylene fibers for a certain application can be further reduced compared to when using glass fibers and/or aramid fibers.

Furthermore, the use of polypropylene fibers in the fibre containing elongate armoring element of an unbonded flexible pipe substantially reduces the cost compared to using the fibers that are suggested today, such as aramid fibers and carbon fibers.

It should be emphasized that the term “comprises/comprising” when used herein is to be interpreted as an open term, i.e. it should be taken to specify the presence of specifically stated feature(s), such as element(s), unit(s), integer(s), step(s) component(s) and combination(s) thereof, but does not preclude the presence or addition of one or more other stated features.

All features of the invention including ranges and preferred ranges can be combined in various ways within the scope of the invention, unless there are specific reasons not to combine such features.

The unbonded flexible pipe of the invention is preferably adapted for use for transportation of water or of aggressive fluids, such a petrochemical products, e.g. from a production well to a sea surface installation.

The flexible unbonded pipe of the invention may e.g. be as described in “Recommended Practice for Flexible Pipe”, ANSI/API 17 B, fourth Edition, July 2008, and the standard “Specification for Unbonded Flexible Pipe”, ANSI/API 17J, Third edition, July 2008 with the exception that at least one armoring layer comprises at least one helically wound fibre containing elongate armoring element as described below.

The flexible unbonded pipe of the invention has a length and a centre axis along its length.

The unbonded flexible pipe has a length and comprises a tubular inner sealing sheath, which is the innermost sealing sheath forming a barrier against fluids and which defines a bore through which the fluid can be transported. The unbonded flexible pipe has a centre axis, which is the central axis of the bore. Usually the bore will be substantially circular in cross-section, but it may also have other shapes, such as oval.

The flexible unbonded pipe of the invention may preferably comprise a carcass located inside the inner sealing sheath of the pipe. The carcass is in particular useful in pipes adapted for use in situations where the pipe will be subjected to high hydrostatic forces e. g. for use at deep water. The main function of the carcass is to prevent collapse of the inner sealing sheath.

The unbonded flexible pipe of the invention further comprises at least one armoring layer comprising at least one helically wound fibre containing elongate armoring element.

In one embodiment the armoring layer consists of one helically wound fibre containing elongate armoring element.

In one embodiment the armoring layer consists of a plurality of helically wound fibre containing elongate armoring elements.

In one embodiment the armoring layer consists of one or a plurality of helically wound fibre containing elongate armoring elements and additional elements with a non-armoring effect, such as helically wound elongate polymer elements applied between windings of the helically wound fibre containing elongate armoring element(s) and/or sensor arrangements. The term “element with a non-armoring effect” is herein used to mean an element which does not affect the overall armoring of the unbonded flexible pipe—i.e. the element does not in itself add physical strength to the unbonded flexible pipe. The elements with a non-armoring effect may for example have a stabilizing effect or a protecting effect which increases the strength of the helically wound fibre containing elongate armoring elements.

In one embodiment the unbonded flexible pipe has one single armoring layer comprising at least one helically wound fibre containing elongate armoring element.

In one embodiment the unbonded flexible pipe has two or more armoring layers comprising at least one helically wound fibre containing elongate armoring element.

The fibre containing elongate armoring element comprises polymer material and at least about 5% by weight of polypropylene fibers.

The terms “polymer” and “polymer material” are used interchangeably and designate a polymer or a mixture and/or a combination of two or more polymers. The polymer may e.g. be a fiber reinforced polymer comprising all or a part of the at least 5% by weight of polypropylene fibers.

In one embodiment the fibre containing elongate armoring element comprises at least about 10% by weight of polypropylene fibers.

In one embodiment the fibre containing elongate armoring element comprises at least about 30% by weight of polypropylene fibers.

In one embodiment the fibre containing elongate armoring element comprises at least about 40% by weight of polypropylene fibers.

In one embodiment the fibre containing elongate armoring element comprises at least about 50% by weight of polypropylene fibers.

In one embodiment the fibre containing elongate armoring element comprises at least about 60% by weight of polypropylene fibers.

In one embodiment the fibre containing elongate armoring element comprises at least about 70% by weight of polypropylene fibers.

In one embodiment the fibre containing elongate armoring element comprises at least about 75% by weight of polypropylene fibers.

In one embodiment the fibre containing elongate armoring element comprises at least about 80% by weight of polypropylene fibers.

The higher strength that is required, the higher amount of polypropylene fibers relative to the amount of polymer is it desired to apply.

In one embodiment the fiber containing elongate armoring element comprises up to about 90% by weight of polypropylene fibers.

In one embodiment the fiber containing elongate armoring element comprises from about 20% by weight to about 90% by weight of polypropylene fibers.

The polypropylene fibers have a very low weight relative to their strength and in particular in comparison with steel but also compared with carbon fibers, aramid fibers and glass fibers and further polypropylene fibers are much cheaper than carbon and aramid fibers. The solution provided by this invention is therefore in particular beneficial in situations where a high strength of the unbonded flexible pipe is required, such as for use in riser pipes or pipes for deep water applications. Surprisingly it has been found that the unbonded flexible pipe of the invention is particularly useful for dynamic applications. The polypropylene fibers have shown to be very durable and may even increase the durability of the unbonded flexible pipe subjected to dynamic bends and/or stretch, such as when the unbounded flexible pipe is a riser.

The polypropylene fibers comprise any fibers with a polymeric composition comprising propylene monomers, either alone (i.e., homopolymer) or in mixture or copolymer with other polyolefins, dienes, or other monomers (such as ethylene, butylene, and the like). The term is also intended to encompass any different configuration and arrangement of the constituent monomers (such as syndiotactic, isotactic, and the like).

In one embodiment the polypropylene fibers have a material composition comprising about 50% or more of polypropylene.

In one embodiment the polypropylene fibers have a material composition comprising about 75% or more of polypropylene.

In one embodiment the polypropylene fibers consist essentially of polypropylene.

Examples of useful polypropylene fibers and methods for their productions are described in U.S. Pat. No. 3,432,590, U.S. Pat. No. 4,413,110, U.S. Pat. No. 7,074,483, U.S. Pat. No. 7,445,834, US 7,445,842 and US 2006/0280924.

Table 1 below shows properties of typical fibers suggested for use in an unbonded flexible pipe compared to properties of a polypropylene fibers. Although the tensile strength of the polypropylene fibers is lower than the tensile strength of aramid fibers, carbon fibers and glass fibers, the low weight of the polypropylene fibers and the relative low cost of the polypropylene fibers have shown to be very beneficial and allow the use of a higher volume of polypropylene fibers to reach the desired strength of the fibre containing elongate armoring elements.

| | Density | Tensile Strength | Tensile modulus |
|---|---|---|---|
| Fiber | (g/cm³) | (Mpa) | (Gpa) |
| Polypropylene | 0.84 | 590-630 | 14-18 |
| (Innegra) | | | |
| Aramid (Kevlar K29) | 1.44 | 2900 | 70 |
| Carbon (Pan with | 1.76 | 1700 | 302 |
| modulus) | | | |
| E-Glass | 2.55 | 2600 | 72 |

In one embodiment the fibre containing elongate armoring element essentially has the composition in % by weight
from about 5% to about 90% of polypropylene fibers,
from about 10% to about 95% of polymer,
from 0% and up to about 20% of other fibers, preferably comprising carbon fibers, glass fibers, aramid fibers, basalt fibers, steel fibers, polyethylene fibers, mineral fibers and/or mixtures comprising at least one of the foregoing fibers,
from 0% and up to about 20% of non-fibrous additives selected from fillers and extenders.

The term “essentially” is herein used to mean that the fibre containing elongate armoring element may comprise insignificant amounts of other components, such as impurities and similar.

In one embodiment the fiber containing elongate armoring element essentially has the composition in % by weight
from about 5% to about 80% of polypropylene fibers,
from about 20% to about 95% of polymer,
from 0% and up to about 20% of other fibers, preferably comprising carbon fibers, glass fibers, aramid fibers, basalt fibers, steel fibers, polyethylene fibers, mineral fibers and/or mixtures comprising at least one of the foregoing fibers,
from 0% and up to about 20% of non-fibrous additives selected from fillers and extenders.

In accordance with the present invention it is desired that the fibre containing elongate armoring element does not comprise less than about 5% of polypropylene fibers since this will result in an armoring element which is either too expensive—e.g. if applying carbon fibers instead; has too low strength or has too low durability—e.g. if applying aramid fibers or glass fibers instead. Preferably the fiber containing elongate armoring element comprises at least about 20% by weight of polypropylene fibers.

In one embodiment the fibre containing elongate armoring element comprises carbon fibers, glass fibers, aramid fibers, basalt fibers, steel fibers, polyethylene fibers, mineral fibers and/or mixtures and/or combinations comprising at least one of the foregoing fibers. In one embodiment preferably the fibre containing elongate armoring element comprises a mixture or a combination of polypropylene fibers and glass fibers or a mixture or a combination of polypropylene fibers and aramid fibers.

The term “mixtures of fibers” means mixtures where the individual fibers are physically mixed with each other e.g. as hybrid fibers e.g. as described in the article “Weight Reduction and Cost Savings Using Hybrid Composites Containing High Modulus Polypropylene Fiber” Composites & Polycon 2009—American Composites Manufacturers Association, Jan. 15-17, 2009. The term “combinations of fibers” means combinations where the individual fibers are not physically mixed with each other.

In one embodiment the fibre containing elongate armoring element essentially has the composition in % by weight
from about 30% to about 70% of polypropylene fibers,
from about 20% to about 60% of polymer,
from 10% and up to about 30% of other fibers, preferably comprising carbon fibers, glass fibers, aramid fibers, Basalt fibers, steel fibers, polyethylene fibers, mineral fibers and/or mixtures comprising at least one of the foregoing fibers,
from 0% and up to about 20% of non-fibrous additives selected from fillers and extenders.

In this embodiment the fibre containing elongate armoring element comprises at least about 10% of other fibers than polypropylene fibers, e.g. carbon fibers, glass fibers, aramid fibers, basalt fibers, steel fibers, polyethylene fibers, mineral fibers and/or mixtures and/or combinations comprising at least one of the foregoing fibers. Thereby different properties may be combined or cost may be reduced. In one embodiment the fibre containing elongate armoring element comprises glass fibers—since glass fibers are often cheaper than polypropylene fibers, the total cost of the fibre containing elongate armoring element can be reduced by providing that some of the fibers are glass fibers. In one embodiment the fibre containing elongate armoring element comprises carbon fibers—carbon fibers have a higher elastic modulus (around 250-300 GPa) than polypropylene fibers (around 14 GPa), the fibre containing elongate armoring element can thereby be provided with a higher stiffness than it would have without carbon fibers. Additional examples of combinations are disclosed below.

In one embodiment the polypropylene fibers are mixed with other fibers to hybrid fibers e.g. as described in the article “Weight Reduction and Cost Savings Using Hybrid Composites Containing High Modulus Polypropylene Fiber” Composites & Polycon 2009—American Composites Manufacturers Association, Jan. 15-17, 2009.

In one embodiment the fibre containing elongate armoring element comprises basalt/polypropylene hybrid fibers.

In one embodiment the fibre containing elongate armoring element comprises carbon/polypropylene hybrid fibers.

In one embodiment the fibre containing elongate armoring element comprises aramid/polypropylene hybrid fibers.

The fibre containing elongate armoring element has a length direction along its elongate shape. The length direction of the fibre containing elongate armoring element is different from the length direction of the flexible unbonded pipe and the two directions have an angle to each other which is similar to the winding angle of the fibre containing elongate armoring element, which is the winding angle of the fibre containing elongate armoring element with respect to the center axis of the flexible unbonded pipe.

The polypropylene fibers may be any type of polypropylene fibers or combinations of polypropylene fibers.

In one embodiment the polypropylene fibers comprise one or more cut fibers and/or, filaments; strands comprising at least one of the foregoing, yarns comprising at least one of the foregoing, rovings comprising at least one of the foregoing , fibre bundles comprising at least one of the foregoing. The polypropylene fibers may in one embodiment comprise a fibre bundle comprising spun, knitted, woven, braided fibers and/or are in the form of a regular or irregular network of fibers and/or a fibre bundle cut from one or more of the foregoing.

The term “cut fibers” means herein fibers of a non continuous length, e.g. in the form of chopped fibers or melt blown fibers. The cut fibers are usually relatively short fibers e.g. less than about 5 cm, such as from about 1 mm to about 3 cm in length. The cut fibers may have equal or different lengths.

Filaments are continuous single fibers (also called monofilament).

The phrase “continuous” as used herein in connection with fibers, filaments, strands, or rovings, means that the fibers, filaments, strands, yarns, or rovings means that they generally have a significant length but should not be understood to mean that the length is perpetual or infinite. Continuous fibers, such as continuous filaments, strands, yarns, or rovings preferably have a length of at least about 10 m, preferably at least about 100 m, more preferably at least about 1000 m.

The term “strand” is used to designate an untwisted bundle of filaments.

The term “yarn” is used to designate a twisted bundle of filaments and/or cut fibers. Yarn includes threads and ropes. The yarn may be a primary yarn made directly from filaments and/or cut fibers or a secondary yarn made from yarns and/or cords. Secondary yarns are also referred to as cords.

The term “roving” is used to designate an untwisted bundle of strands or yarns. A roving includes a strand of more than two filaments. A non twisted bundle of more than two filaments is accordingly both a strand and a roving.

If other fibers than the polypropylene fibers are present in the fibre containing elongate armoring element, these fibers may be in any form e.g. in the form of one or more cut fibers and/or, filaments; strands comprising at least one of the foregoing, yarns comprising at least one of the foregoing, rovings comprising at least one of the foregoing , fibre bundles comprising at least one of the foregoing, for example in the form of at least one fibre bundle comprising spun, knitted, woven, braided fibers and/or are in the form of a regular or irregular network of fibers and/or at least one fibre bundle cut from one or more of the foregoing.

If other fibers than the polypropylene fibers are present in the fibre containing elongate armoring element the other fibers may in the same form(s) as the polypropylene fibers or they may be in different form(s) than the polypropylene fibers.

If other fibers than the polypropylene fibers are present in the fibre containing elongate armoring element, the other fibers may be mixed with the polypropylene fibers, e.g. as hybrid fibers or they may be non-mixed with the polypropylene fibers.

In one embodiment the major amount, preferably at least about 60% by weight of the polypropylene fibers is in the form of continuous fibers, such as continuous filaments, continuous yarns, continuous rovings or combinations thereof. By using continuous fibers the reinforcement provided by the fibers can be directed in the direction or directions where it is desired.

In one embodiment at least some and preferably at least about 50% by weight of the polypropylene fibers, more preferably substantially all of the polypropylene fibers are arranged in a direction predominantly parallel to the elongate direction of the fibre containing elongate armoring element. In this embodiment at least a part of the polypropylene fibers are preferably continuous fibers. The term “substantially all” means herein that a minor amount such as up to about 5% by weight, preferably about 2% or less of the polypropylene fibers can be arranged in another direction. The term “predominantly” means that small variations within production tolerances are considered to be parallel as well.

By providing that the polypropylene fibers are arranged in a direction predominantly parallel to the elongate direction of the fibre containing elongate armoring element, the tensile strength of the fibre containing elongate armoring in the length direction thereof is very high.

If cut fibers are used it is generally desired that they have a length of at least about 5 μm in order to ensure that they do not become airborne during production and thereby may have a hazardous effect on workers inhaling such fibers. Above this length any length of fiber can be applied in any combination.

The diameter of the fibers is not so important and may for example be between about 5 μm and 25 μm.

In one embodiment the major amount, preferably at least about 60% by weight of the polypropylene fibers has a diameter of about 10 μm or more (about 1 denier), such as a diameter of about 12 μm or more, such as a diameter of about 15 μm or more. In one embodiment substantially all of the polypropylene fibers have a diameter in the interval of from about 10 μm to about 200 μm, such as from 20-150 mm. Fibers with a diameter within this range of diameter are generally relatively easy to handle.

The polymer of the fibre containing elongate armoring element may be any kind of polymer or combinations of polymers which are compatible with the fibers. When selecting polymer the application of the flexible unbonded pipe should preferably be considered such that the polymer can tolerate possible heat and possible chemical influences that it may be subjected during use.

Examples of polymers of the fibre containing elongate armoring element are the following:

polyolefins, e.g. polyethylene or poly propylene;
polyamide, e.g. poly amide-imide, polyamide-11 (PA-11), polyamide-12 (PA-12) or polyamide-6 (PA-6));
polyimide (PI);
polyurethanes;
polyureas;
polyesters;
polyacetals;
polyethers, e.g. polyether sulphone (PES);
polyoxides;
polysulfides, e.g. polyphenylene sulphide (PPS);
polysulphones, e.g. polyarylsulphone (PAS);
polyacrylates;
polyethylene terephthalate (PET);
polyether-ether-ketones (PEEK);
polyvinyls;

polyacrylonitrils;

polyetherketoneketone (PEKK);
fluorous polymers e.g. polyvinylidene diflouride (PVDF), copolymers of the preceding;
homopolymers or copolymers of vinylidene fluoride (“VF2”),
homopolymers or copolymers of trifluoroethylene (“VF3”),
copolymers or terpolymers comprising two or more different members selected from VF2, VF3, chlorotrifluoroethylene, tetrafluoroethylene, hexafluoropropene, or hexafluoroethylene; and
compounds comprising one or more of the above mentioned polymers as well as the below mentioned thermoset polymers.

The above polymers may be applied in combinations e.g. layered or laminated or mixed.

In one embodiment the polymer of the fibre containing elongate armoring element(s) comprises a thermoset polymer, preferably selected from epoxy resins, vinyl-epoxy-ester resins, polyester resins, polyimide resins, bis-maleimide resins, cyanate ester resins, vinyl resins, benzoxazine resins, benzocyclobutene resins, or mixtures comprising at least one of the forgoing thermoset polymers.

In one embodiment the polymer of the fibre containing elongate armoring element(s) comprises a thermoplastic polymer, such as polyolefin, polyamide, polyimide, polyamide-imide, polyester, polyurethane and polyacrylate.

In one embodiment the fibre containing elongate armoring element comprises or consists of composite material. The composite material may e.g. be a composite-embedded polymer provided by embedding the fibers in the polymer. The fibers embedded in the composite-embedded polymer may have any form e.g. as described above. In one embodiment the fibers embedded in the composite-embedded polymer are continuous fibers. By producing the composite polymer as a composite-embedded polymer, the reinforcing fibers can in a simple manner be arranged as desired and with concentration variations as desired.

In one embodiment the composite material is provided by pultrusion. Pultrusion processes are generally known in the art and are e.g. described in U.S. Pat. No. 6,872,343. The pultrusion may provide a simple process for providing a fibre containing elongate armoring element with a high amount of fiber to polymer.

In one embodiment wherein the fibre containing elongate armoring element comprises composite material of fibers in a thermoset polymer provided by pultrusion, the fibre containing elongate armoring element does not have an untensioned diameter between about 5 cm and about 5 m.

In one embodiment the fibre containing elongate armoring element is not produced by pultrusion.

In one embodiment the composite material is a composite-mixed polymer provided by mixing cut fibers into the molten polymer prior to shaping the polymer. By this method a polymer with a homogenous distribution of fibers can be provided.

In one embodiment the fibers are substantially homogeneously distributed in the polymer.

In one embodiment the fibers are inhomogeneously distributed in the polymer.

In one embodiment the elongate armoring element comprises a layer of polymer with a high concentration of fibers, sandwiched between two layers of polymers with a low concentration of fibers. The layers of polymer preferably extend along the length of the elongate armoring element. The polymer in the individual layers may be identical or different from each other. Naturally the fibre containing elongate armoring element may comprise additional layers with or without fibers.

The fibers in the individual layers may be equal or different from each other. For example the elongate armoring element may comprise a layer of polymer reinforced with aramid fibers and/or glass fibers sandwiched between two layers of polymers reinforced with polypropylene fibers. By sandwiching a layer of polymer reinforced with aramid fibers and/or glass fibers between two layers of polymers reinforced with polypropylene fibers, the sandwiching layers with polypropylene fibers may provide a protection of the aramid fibers and/or glass fibers in the sandwiched layer against hydrolysis.

In one embodiment the fibre containing elongate armoring element comprises fibers partly or totally embedded in polymer, the fibers are preferably in the form of continuous fibers, such as continuous filaments, continuous yarns, continuous rovings or combinations thereof.

In one embodiment the fibre containing elongate armoring element comprises fibers sandwiched between layers of polymer.

In one embodiment the fibers are in the form of continuous fibers, such as continuous filaments, continuous yarns, continuous rovings or combinations thereof.

In one embodiment the continuous fibers are in the form of bundles of continuous fibers applied between two layers of polymer with the length direction of the fibers parallel to the length direction of the fibre containing elongate armoring element. The bundles of fibers are placed in a side by side relation with intersections between the bundles of fibers where the polymer layers are bonded to each other. The bundles of fibers are preferably held between the layers of polymers such that the fibers in direct contact with one of the polymer layers are at least partly bonded to this polymer layer, whereas the fibers of the bundles which are not in direct contact with one of the polymer layers are held mechanically between the two polymer layers.

In one embodiment where the fibre containing elongate armoring element comprises fibers sandwiched between layers of polymer, the layers of polymer are different from each other.

In one embodiment where the fibre containing elongate armoring element comprises fibers sandwiched between layers of polymer, the layers of polymer are equal other.

In one embodiment where the fibre containing elongate armoring element comprises fibers sandwiched between layers of polymer, an adhesive is applied to a face facing the fibers of one or both of the polymer layers to ensure bonding between the polymer layers in intersections between the bundles of fibers.

In one embodiment where the fibre containing elongate armoring element comprises fibers sandwiched between layers of polymer, at least one of the polymer layers is a composite polymer reinforced with fibers.

In one embodiment where the fibre containing elongate armoring element comprises fibers sandwiched between layers of polymer, at least one of the polymer layers is a polyethylene (PE), such as a high density polyethylene (HDPE) optionally cross linked PE/HDPE.

The fibre containing elongate armoring element may have a varying profile or a constant profile along its length. The profile of the fibre containing elongate armoring element means the shape of a cross sectional cut through the fibre containing elongate armoring element. The term “profile” and “cross-sectional profile” are used interchangeably. Generally it is desired that the profile of the fibre containing elongate armoring element is substantially constant along its length, however, in one embodiment the profile of the fibre containing elongate armoring element is substantially constant with the exception that the thickness of the fibre containing elongate armoring element varies along its length.

The thickness of the fibre containing elongate armoring element in a point along its length is determined as the maximal thickness of the fibre containing elongate armoring element in the point along its length measured in axial direction of the fibre containing elongate armoring element.

The fibre containing elongate armoring element may in principle have any profile. For example it may have a profile which is substantially rectangular, U shaped, I shaped, C shaped, T-shaped, K shaped, Z shaped, X shaped, Ψ (psi) shaped and combinations thereof.

In a preferred embodiment the fibre containing elongate armoring element has a substantially rectangular shape, e.g. shaped as a strip, such as a tape.

In one embodiment the fibre containing elongate armoring element has a thickness of at least about 1 mm, such as at least about 2 mm, such as at least about 3 mm, such as at least about 4 mm, such as at least about 5 mm, such as at least about 6 mm, such as at least about 7 mm, such as at least about 8 mm, such as at least about 9 mm, such as at least about 10 mm.

The fibre containing elongate armoring element has a width. The width of the fibre containing elongate armoring element may vary but generally it is preferred that the width of the fibre containing elongate armoring element is substantially constant along the length of the fibre containing elongate armoring element.

The width of the fibre containing elongate armoring element in a point along its length is determined as the maximal width of the fibre containing elongate armoring element in the point along its length measured perpendicular to the thickness of the fibre containing elongate armoring element.

If the width of the fibre containing elongate armoring element is too narrow, the production cost may be increased since the helical winding of the fibre containing elongate armoring element will require an excessive number of windings, whereas if the width of the fibre containing elongate armoring element is too large, the fibre containing elongate armoring element may provide a too high stiffness of the unbonded flexible pipe or the application of the fibre containing elongate armoring element may be difficult.

A width of the fibre containing elongate armoring element in the interval from about 2 mm to about 25 mm is normally preferred.

In one embodiment the fibre containing elongate armoring element has a width of from about 2 mm to about 20 cm, such as from about 3 mm to about 10 cm, such as from about 5 mm to about 5 cm, such as from about 8 mm to about 2 cm.

In one embodiment the fibre containing elongate armoring element is shaped as a tape with a width to thickness ration of from about 2:1 to about 100:1. Preferably the thickness of the tape is about 1 cm or less, preferably from about 1 mm to about 5 mm. Preferably the tape has a width of about 2 mm or more, more preferably about 2 cm or more.

In one embodiment the pipe comprises at least one armoring layer comprising a plurality of helically wound fibre containing elongate armoring elements comprising at least about 5% by weight, preferably comprising at least about 10% by weight of polypropylene fibers, more preferably at least about 30% by weight.

In one embodiment the at least one armoring layer comprising the helically wound fibre containing elongate armoring element(s) is a pressure armor layer and the helically wound fibre containing elongate armoring element(s) is/are wound with a degree to the centre axis which is about 75 degree or higher, such as about 80 degree or higher, such as about 85 degree or higher.

In one embodiment the at least one armoring layer comprising the helically wound fibre containing elongate armoring element(s) is balanced or tensile armor layer, and the helically wound fibre containing elongate armoring element(s) is/are wound with a degree to the centre axis which is about 65 degree or lower, such as about 60 degree or lower, such as about 55 degree or lower.

In one embodiment the pipe comprises at least two armoring layers comprising the helically wound polypropylene fibre containing elongate armoring element(s), which are cross wound with respect to each other and wound with a degree to the centre axis which is about 65 degree or lower, such as about 60 degree or lower, such as about 55 degree or lower.

In one embodiment the pipe comprises two or more tensile armor layers and where all the tensile armor layers are of the same material or of the same combination of materials.

The invention will be explained more fully below in connection with description of specific examples.

### EXAMPLE 1

Example of a tape shaped fibre containing elongate armoring element with only polypropylene fibers.

| | |
|---|---|
| Polymer | PE |
| Polypropylene | Continuous filaments |
| fibers | Density 0.84 g/cm³ |
| Innegra S ™ | Diameter about 12.5 denier |
| | Tensile strength 590 MPa |
| | Elastic modulus 240 GPa |
| | Elongation at break 7.2% |
| Amount of | 20% by weight of fibre containing elongate armoring |
| Polypropylene | element |
| fibers | |
| Other fibers | No |
| Shape | Shaped as a tape with rectangular shape |
| | Width: About 5 cm |
| | Thickness: About 2 mm |
| Structure | 20 bundles of polypropylene filaments sandwiched |
| | between polymer layers, parallel with the fibre |
| | containing elongate armoring element and with |
| | intersections where the polymer layers are bonded to |
| | each other. |
| | Each bundle of polypropylene fibers comprises 100- |
| | 100000 filaments. |
| Additional | No |
| layers | |

### EXAMPLE 2

Example of a tape shaped fibre containing elongate armoring element with polypropylene fibers and glass fibers.

| | |
|---|---|
| Polymer | PVDF |
| Polypropylene | Continuous filaments |
| fibers | Density 0.84 g/cm³ |
| | Diameter about 10 denier |
| | Tensile strength 590 MPa |
| | Elastic modulus 240 GPa |
| | Elongation at break 7.2% |
| Amount of | 20% by weight of fibre containing elongate armoring |
| Polypropylene | element. |
| fibers | |
| Other fibers | Cut glass fibers (3% by weight of fibre containing |
| | elongate armoring element) |
| Shape | Shaped as a tape with rectangular shape |
| | Width: About 5 cm |
| | Thickness: About 2 mm |
| Structure | 20 bundles of polypropylene filaments sandwiched |
| | between polymer layers, parallel with the fibre |
| | containing elongate armoring element and with |
| | intersections where the polymer layers are bonded to |
| | each other. |
| | Each bundle of polypropylene fibers comprises 100- |
| | 100000 filaments. |
| | Polymer layers are of PVDF reinforced with glass fibers |
| | homogeneously distributed. Fiber directions are |
| | random |
| Additional | No |
| layers | |

### EXAMPLE 3

Example of fibre containing elongate armoring element with pultruded polypropylene fibers

| | |
|---|---|
| Polymer | Epoxy |
| Polypropylene | Continuous fibers in form of a network of filaments. |
| fibers | Filaments have the properties: |
| | Density 0.84 g/cm³ |
| | Diameter about 12.5 denier |
| | Tensile strength 590 MPa |
| | Elastic modulus 240 GPa |
| | Elongation at break 7.2% |
| Amount of | 80% by weight of fibre containing elongate armoring |
| Polypropylene | element. |
| fibers | |
| Other fibers | No |
| Shape | Shaped with rectangular shape |
| | Width: About 1 cm |
| | Thickness: About 2 mm |
| Structure | Polypropylene filaments impregnated with polymer in a |
| | pultrusion process |
| Additional | No |
| layers | |

### EXAMPLE 4

Example of a tape shaped fibre containing elongate armoring element with hybrid aramid/polypropylene fibers.

| | |
|---|---|
| Polymer | HDPE |
| Hybrid aramid/ | 20/80 weight % aramid fibers/polypropylene fibers |
| polypropylene | twisted to hybrid yarns |
| fibers | |
| Amount of hybrid | 50% by weight of fibre containing elongate armoring |
| fibers | element. |
| Other fibers | No |
| Shape | Shaped as a tape with rectangular shape |
| | Width: About 5 cm |
| | Thickness: About 2 mm |
| Structure | 20 bundles of hybrid yarns sandwiched between |
| | polymer layers, parallel with the fibre containing |
| | elongate armoring element and with intersections |
| | where the polymer layers are bonded to each other. |
| | Each yarn comprises 100-10000 filaments. |
| | Polymer layers are of cross linked PE |
| Additional | No |
| layers | |

### EXAMPLE 5

A flexible unbonded pipe comprising the fiber containing elongate armoring element of Example 1 is produced. The flexible unbonded pipe has from inside out the following layers:

A steel carcass.

A 4 mm thick extruded inner sealing sheath of cross-linked HDPE.

A pressure armoring layer of steel provided by winding a steel wire helically with a winding degree of about 85 to the centre axis of the pipe.

An extruded intermediate liquid permeable layer of HDPE (about 2 mm in thickness).

A first tensile armoring layer provided by a plurality of the fiber containing elongate armoring element of example 1, helically wound with a winding degree of about 45 to the centre axis of the pipe.

A second tensile armoring layer provided by a plurality of the fibre containing elongate armoring element of example 1, helically wound with a winding degree of about 40 to the centre axis of the pipe and with a winding direction opposite to the winding direction of the first tensile layer.

Further scope of applicability of the present invention will become apparent from the detailed description given above. However, it should be understood that the detailed description and specific examples, while indicating preferred embodiments of the invention, are given by way of illustration only, since various changes and modifications within the spirit and scope of the invention will become apparent to those skilled in the art from this detailed description.

Some preferred embodiments have been shown in the foregoing, but it should be stressed that the invention is not limited to these, but may be embodied in other ways within the subject-matter defined in the following claims.

What is claimed is:

1-27. (canceled)

28. An unbonded flexible offshore pipe having a length and a centre axis along its length, the unbonded flexible pipe comprising an internal sealing sheath surrounding said centre axis, the pipe further comprises at least one armoring layer comprising at least one helically wound fibre containing elongate armoring element, the fibre containing elongate armoring element comprises polymer material, and at least about 5% by weight of polypropylene fibers.

29. The unbonded flexible pipe as claimed in claim 28, wherein the fibre containing elongate armoring element essentially has the composition in % by weight
from about 5% to about 90% of polypropylene fibers,
from about 10% to about 95% of polymer,
from 0% and up to about 20% of other fibers comprising carbon fibers, glass fibers, aramid fibers, basalt fibers, steel fibers, polyethylene fibers, mineral fibers or mixtures comprising at least one of the foregoing fibers,
from 0% and up to about 20% of non-fibrous additives selected from fillers and extenders.

30. The unbonded flexible pipe as claimed in claim 28, wherein the fibre containing elongate armoring element essentially has the composition in % by weight
from about 30% to about 80% of polypropylene fibers,
from about 10% to about 60% of polymer,
from 10% and up to about 30% of other fibers comprising carbon fibers, glass fibers, aramid fibers, basalt fibers, steel fibers, polyethylene fibers, mineral fibers or mixtures comprising at least one of the foregoing fibers,
from 0% and up to about 20% of non-fibrous additives selected from fillers and extenders.

31. The unbonded flexible pipe as claimed in claim 28, wherein the fibre containing elongate armoring element has a length direction along its elongate shape, the polypropylene fibers are arranged in a direction predominantly parallel to the elongate direction of the fibre containing elongate armoring element.

32. The unbonded flexible pipe as claimed in claim 28, wherein the polypropylene fibers comprise one or more cut fibers or, filaments; strands comprising at least one of the foregoing, yarns comprising at least one of the foregoing, rovings comprising at least one of the foregoing or fibre bundles comprising at least one of the foregoing.

33. The unbonded flexible pipe as claimed in claim 28, wherein at least about 60% by weight of the polypropylene fibers, is in the form of continuous fibers.

34. The unbonded flexible pipe as claimed in claim 28, wherein the major amount of the polypropylene fibers, has a diameter of about 10 μm or more.

35. An unbonded flexible pipe as claimed in claim 28, wherein the polymer of the fibre containing elongate armoring element(s) comprises a thermoset polymer selected from epoxy resins, vinyl-epoxy-ester resins, polyester resins, polyimide resins, bis-maleimide resins, cyanate ester resins, vinyl resins, benzoxazine resins, benzocyclobutene resins, or mixtures comprising at least one of the forgoing thermoset polymers.

36. The unbonded flexible pipe as claimed in claim 28, wherein the polymer of the fibre containing elongate armoring element(s) comprises a thermoplastic polymer selected from polyolefin, polyamide, polyimide, polyamide-imide, polyester, polyurethane and polyacrylate.

37. The unbonded flexible pipe as claimed in claim 28, wherein the fibre containing elongate armoring element comprises carbon fibers, glass fibers, aramid fibers, basalt fibers, steel fibers, polyethylene fibers, mineral fibers or mixtures or combinations comprising at least one of the foregoing fibers.

38. The unbonded flexible pipe as claimed in claim 28, wherein the fibre containing elongate armoring element comprises or consists of composite material the fibers are substantially homogeneously distributed in the polymer.

39. The unbonded flexible pipe as claimed in claim 28 wherein the fibre containing elongate armoring element comprises or consists of composite material and the fibers are inhomogeneously distributed in the polymer, the elongate armoring element comprises a layer of polymer with a high concentration of fibers sandwiched between two layers of polymers with a low concentration of fibers.

40. The unbonded flexible pipe as claimed in claim 39 wherein the elongate armoring element comprises a layer of polymer reinforced with aramid fibers and/or glass fibers sandwiched between two layers of polymers reinforced with polypropylene fibers.

41. The unbonded flexible pipe as claimed in claim 28, wherein the fibre containing elongate armoring element comprises fibers partly or totally embedded in polymer, the fibers are in the form of continuous fibers.

42. The unbonded flexible pipe as claimed in claim 28, wherein the fibre containing elongate armoring element comprises fibers sandwiched between layers of polymer, the fibers are in the form of continuous fibers.

43. The unbonded flexible pipe as claimed in claim 28, wherein the fibre containing elongate armoring element is in the form of a strip having a thickness of at least about 1 mm.

44. The unbonded flexible pipe as claimed in claim 28, wherein the fibre containing elongate armoring element has a width of from about 2 mm to about 20 cm.

45. The unbonded flexible pipe as claimed in claim 28, wherein the fibre containing elongate armoring element has an essentially constant cross-sectional profile.

46. The unbonded flexible pipe as claimed in claim 28, wherein the fibre containing elongate armoring element is shaped as a tape with a width to thickness ration of from about 2:1 to about 100:1.

47. The unbonded flexible pipe as claimed in claim 28, wherein the pipe comprises at least one armoring layer comprising a plurality of helically wound fibre containing elongate armoring elements comprising at least about 5% by weight of polypropylene fibers.

48. The unbonded flexible pipe as claimed in claim 28, wherein the at least one armoring layer comprising the helically wound fibre containing elongate armoring element(s) is a pressure armor layer and the helically wound fibre containing elongate armoring element(s) is/are wound with a degree to the centre axis which is about 75 degree or higher.

49. The unbonded flexible pipe as claimed in claim 28, wherein the at least one armoring layer comprising the helically wound fibre containing elongate armoring element(s) is balanced or tensile armor layer and the helically wound fibre containing elongate armoring element(s) is/are wound with a degree to the centre axis which is about 65 degree or lower.

50. The unbonded flexible pipe as claimed in claim 49, wherein the pipe comprises at least two armoring layers comprising the helically wound polypropylene fibre containing elongate armoring element(s), which are cross wound with respect to each other and wound with a degree to the centre axis which is about 65 degree or lower.

51. The unbonded flexible pipe as claimed in claim 28, wherein the fibre containing elongate armoring element comprises composite material of fibers in a thermoset polymer provided by pultrusion, the fibre containing elongate armoring element does not have an untensioned diameter between about 5 cm and about 5 m.

52. The unbonded flexible pipe as claimed in claim 28, wherein the fibre containing elongate armoring element is not produced by pultrusion.
